(19) United States
(12) Patent Application Publication
(10) Pub. No.: US 2026/0264566 A1
(43) Pub. Date: Sep. 10, 2026

(54) HYBRID VEHICLE AND CONTROL DEVICE

(71) Applicant: TOYOTA JIDOSHA KABUSHIKI KAISHA, Toyota-shi (JP)

(72) Inventors: Yuya AOKI, Miyoshi-shi (JP); Toru Ando, Obu-shi (JP)

(73) Assignee: TOYOTA JIDOSHA KABUSHIKI KAISHA, Toyota-shi (JP)

(21) Appl. No.: 19/532,231

(22) Filed: Feb. 6, 2026

(30) Foreign Application Priority Data
Mar. 5, 2025 (JP) 2025-034966

(51) Int. Cl. B60L 58/12; B60L 50/61

(52) U.S. Cl. CPC B60L 58/12; B60L 50/61; B60L 2250/22

(57) ABSTRACT

A hybrid vehicle according to one aspect of the present disclosure waits for an antenna to receive a signal from an electronic key while continuing to supply battery power to an external device via an external power supply connector, determines whether or not authentication of the electronic key is established based on the signal received by the antenna, and, when the authentication of the electronic key is established, starts charging the battery by driving the internal combustion engine to cause the generator to generate electric power. Charging the battery by driving the internal combustion engine is prohibited until the authentication of the electronic key is established.

### CROSS REFERENCE TO THE RELATED APPLICATION

This application claims the benefit of Japanese Patent Application No. 2025-034966, filed on Mar. 5, 2025, which is hereby incorporated by reference herein in its entirety.

### BACKGROUND

### Technical Field

The present disclosure relates to a hybrid vehicle and a control device.

Japanese Patent Laid-Open No. 2019-162896 proposes a hybrid vehicle that can be configured to supply battery electric power to an external device when the remaining energy of the battery exceeds a certain amount. When supplying power from this battery to an external device, there is a power supply method (HV power supply) that replenishes the power of the battery by driving an internal combustion engine to generate electricity to a generator.

### SUMMARY

One of the purposes of present disclosure is to provide technology for controlling the timing to start driving an internal combustion engine in HV power supply.

The hybrid vehicle according to a first aspect of the present disclosure comprises an internal combustion engine, a generator, a battery, an external power supply connector, an antenna, and a control device. The generator is configured to generate electric power by mechanical power from the internal combustion engine. The battery is connected to the generator through an electric power line. The external power supply connector is configured to supply electric power from the battery to a connected external device. The antenna is configured to receive a signal emitted by an electronic key. The control device is configured to perform waiting for the antenna to receive the signal from the electronic key while continuing to supply electric power from the battery to the external device through the external power supply connector, determining whether or not an authentication of the electronic key is established based on the signal received by the antenna, and in response to the authentication of the electronic key being established, starting charging the battery by driving the internal combustion engine to cause the generator to generate electric power. Charging the battery by driving the internal combustion engine is prohibited until the authentication of the electronic key is established.

The control device according to a first aspect of the present disclosure is installed in a hybrid vehicle comprising an internal combustion engine, a generator configured to generate electric power by mechanical power from the internal combustion engine, a battery connected to the generator through an electric power line, an external power supply connector configured to supply electric power from the battery to a connected external device and an antenna configured to receive a signal emitted by an electronic key. The control device is configured to perform waiting for the antenna to receive the signal from the electronic key while continuing to supply electric power from the battery to the external device through the external power supply connector, determining whether or not an authentication of the electronic key is established based on the signal received by the antenna, and in response to the authentication of the electronic key being established, starting charging the battery by driving the internal combustion engine to cause the generator to generate electric power. Charging the battery by driving the internal combustion engine is prohibited until the authentication of the electronic key is established.

According to present disclosure, it is possible to control the timing of starting the internal combustion engine in the HV power supply.

### BRIEF DESCRIPTION OF THE DRAWINGS

FIG. 1 is a schematic diagram showing an example of the configuration of a hybrid vehicle;

FIG. 2 shows a schematic diagram of an example of a communication range of a hybrid vehicle;

FIG. 3 is a flowchart showing an example of a processing procedure related to HV power supply by the control device;

FIG. 4 is a diagram showing an example of the relationship between the authentication of the electronic key and the remaining energy amount of the battery when HV power supply is performed according to the processing procedure of FIG. 3;

FIG. 5 is a flowchart showing another example of a processing procedure related to HV power supply by the control device;

FIG. 6 is a diagram showing an example of the relationship between the authentication success of the electronic key and the remaining energy amount of the battery when HV power supply is performed in the processing procedure of FIG. 5.

### DESCRIPTION OF THE EMBODIMENTS

In recent years, hybrid vehicles equipped with an internal combustion engine (e.g., engine) and battery have become commercially available. The hybrid vehicle is configured to be able to supply electric power from the battery to external devices. Supplying electric power from a battery to an external device is also called "external power supply". When the remaining energy of the battery becomes low, the hybrid vehicle will no longer be able to maintain a sufficient driving range. Therefore, the hybrid vehicle is configured to enable external power supply while charging the battery by driving an internal combustion engine to cause a generator to generate electric power. This power supply method that supplements the electric power of the battery by driving the internal combustion engine is also called HV power supply. Traditionally, the drive of the internal combustion engine in this HV power supply starts automatically when the remaining energy of the battery reaches the lower limit. The point at which the remaining energy reaches the lower limit depends on the power supply situation. Therefore, it is difficult to control the timing of starting the internal combustion engine to drive.

In contrast, the hybrid vehicle according to a first aspect of the present disclosure comprises an internal combustion engine, a generator, a battery, an external power supply connector, an antenna, and a control device. The generator is configured to generate electric power by mechanical power from the internal combustion engine. The battery is connected to the generator through an electric power line. The external power supply connector is configured to supply electric power from the battery to a connected external device. The antenna is configured to receive a signal emitted by an electronic key. The control device is configured to perform waiting for the antenna to receive the signal from the electronic key while continuing to supply electric power from the battery to the external device through the external power supply connector, determining whether or not an authentication of the electronic key is established based on the signal received by the antenna, and in response to the authentication of the electronic key being established, starting charging the battery by driving the internal combustion engine to cause the generator to generate electric power. Charging the battery by driving the internal combustion engine is prohibited until the authentication of the electronic key is established.

In the first aspect of present disclosure, the authentication of the electronic key is used as a trigger for the drive of the internal combustion engine in the HV power supply. That is, while external power supply is being performed, authentication of the electronic key is performed, and in response to successful authentication of the electronic key, charging of the battery by driving the internal combustion engine is started. This allows the user to start driving the internal combustion engine in the HV power supply when the legitimate electronic key is moved within the area (communication range) that can be communicated with the antenna of the hybrid vehicle and the signal is sent from the legitimate electronic key. Therefore, according to the first aspect of present disclosure, the timing of the start of the drive of the internal combustion engine in the HV power supply can be controlled through the authentication of the electronic key.

As an alternative form of hybrid vehicle related to the above, one aspect of present disclosure may be the control device installed in the hybrid vehicle. In addition, one aspect of present disclosure may be an information processing method by a control device, a program, or a storage medium that can be read by a computer or other machine that stores such a program. Here, a machine-readable storage medium is a medium that accumulates information such as programs through electrical, magnetic, optical, mechanical, or chemical actions.

For example, the control device according to a first aspect of the present disclosure is installed in a hybrid vehicle comprising an internal combustion engine, a generator configured to generate electric power by mechanical power from the internal combustion engine, a battery connected to the generator through an electric power line, an external power supply connector configured to supply electric power from the battery to a connected external device and an antenna configured to receive a signal emitted by an electronic key. The control device is configured to perform waiting for the antenna to receive the signal from the electronic key while continuing to supply electric power from the battery to the external device through the external power supply connector, determining whether or not an authentication of the electronic key is established based on the signal received by the antenna, and in response to the authentication of the electronic key being established, starting charging the battery by driving the internal combustion engine to cause the generator to generate electric power. Charging the battery by driving the internal combustion engine is prohibited until the authentication of the electronic key is established.

### Configuration example

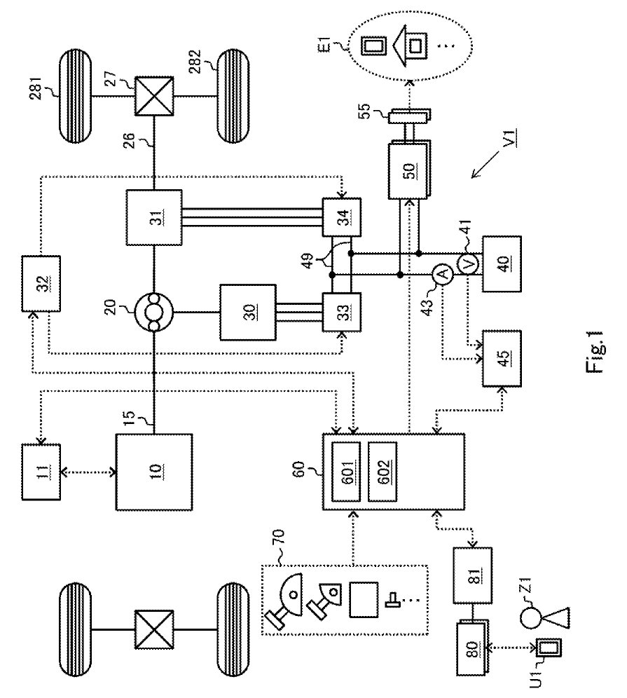

FIG. 1 schematically indicate an example of the configuration of a hybrid vehicle V1 pertaining to the embodiment. The hybrid vehicle V1 according to the embodiment comprises an engine 10, a motor 30, a battery 40, an external power supply connector 55, an antenna 80 and a control device 60.

### Around the engine

The engine 10 is an example of an internal combustion engine. The type of engine 10 (internal combustion engine) may not be limited, and may be appropriately selected according to the embodiment. For example, engine 10 can be configured as an internal combustion engine that outputs mechanical power as a fuel such as gasoline, diesel oil, hydrogen, or the like. For example, a hybrid vehicle V1 may further comprise a control unit 11 for the engine 10, and the operation of the engine 10 may be controlled by the control unit 11.

The configuration of the control unit 11 can be arbitrarily determined. For example, the control unit 11 may be composed of an electronic control unit (ECU) that includes a processor, a memory, an input/output port, a communication port, and the like. The control unit 11 may accept the input of various information (sensor signal, etc.) used to control the engine 10 by means of an input port. Various information may include, for example, the crank angle of the crankshaft 15 of the engine 10, the throttle opening of the throttle valve, the temperature of the cooling water for the engine 10, the amount of fuel remaining in the fuel tank, and the like. The crank angle may be measured by a crank position sensor that detects the rotational position of the crankshaft 15 . The throttle opening may be measured by a throttle valve position sensor that detects the position of the throttle valve. The temperature of the cooling water may be measured by a water temperature sensor. The remaining amount of fuel may be measured by a fuel sensor provided in the fuel tank. The control unit 11 can output a control signal to control the operation of the engine 10 by means of an output port. The control signal to be output may include, for example, a control signal to a throttle motor that adjusts the position of a throttle valve, a control signal to a fuel injection valve, a control signal to an ignition coil, and the like. The control unit 11 may also be connected to the control device 60 via a network using a communication port. The type of network can be optionally selected. The network can be, for example, CAN (Controller Area Network), etc. The control unit 11 may be configured to control the operation of the engine 10 in accordance with control signals from the control device 60 . The control unit 11 may be configured to output data on the operating status of engine 10 to the control device 60. In one example, the control unit 11 may calculate the rotation speed of the crankshaft 15, i.e., the rotation speed of the engine 10, based on the crank angle measured by the crank position sensor. As a result, the control unit 11 may control the operation of the engine 10 while monitoring the rotation speed of the engine 10 as a control variable.

### Around the motor

In one example, the hybrid vehicle V1 may further comprise a planetary gear 20 and a motor 31. The planetary gear 20 may be configured as a single-pinion planetary gear mechanism. The sun gear of the planetary gear 20 may be connected to the rotor of the motor 30 . A drive shaft 26 may be connected to the ring gear of the planetary gear 20 . A pair of drive wheels (281, 282) may be connected to the drive shaft 26 through a differential device 27. The carrier of the planetary gear 20 may be connected to the crankshaft 15 of the engine 10. As a result, the hybrid vehicle V1 can be configured to obtain driving power by outputting the mechanical power of engine 10 to the drive wheels (281 and 282).

In one example, the motor 30 may be configured as a synchronous generator motor. Motor 30 is an example of a generator. The configuration of the generator can be changed arbitrarily. In one example of this embodiment, the power of the engine 10 can be transmitted to the motor 30 via the planetary gear 20 . The motor 30 is configured to generate electric power from mechanical power from the engine 10 transmitted by it. Motor 31 may be configured as a synchronous generator motor. The rotor of the motor 31 may be connected to the drive shaft 26 . The hybrid vehicle V1 may further comprise inverters (33, 34) corresponding to each motor (30, 31) respectively. Each inverter (33, 34) may be connected to the electric power line 49 along with the battery 40. In one example, the hybrid vehicle V1 may further comprise a control unit 32 for the motors (30, 31). Each motor (30, 31) may be driven to rotate by the switching devices of each inverter (33, 34) being controlled by the control unit 32.

The configuration of the control unit 32 may be determined arbitrarily. In one example, similar to the control unit 11, the control unit 32 may be configured by an ECU including a processor, a memory, an input/output port, a communication port, and the like. The control unit 32 may accept the input of various information (sensor signal, etc.) used for the control of each motor (30, 31) by means of an input port. The various information may include, for example, the rotational position of each motor (30, 31), the phase current of each motor (30, 31), and the like. The rotational position (number of rotations) may be measured by an encoder (a sensor that detects the rotational position of the rotor) provided in each motor (30, 31). The phase current may be derived from the measurement of the current sensor, which measures the current flowing through each phase of each motor (30, 31). The control unit 32 may output a control signal to control the operation of each motor (30, 31) by means of an output port. The output control signal may include, for example, a switching control signal to the switching elements of each inverter (33, 34). Also, as with the control unit 11, the control unit 32 may be connected to the control unit 60 through the network by means of a communication port. The control unit 32 may be configured to control the operation of each motor ( 30 , 31 ) according to a control signal from the control device 60 . The control unit 32 may be configured to output data on the operating status of each motor (30, 31) to the control device 60. In one example, the control unit 32 may calculate the number of revolutions of each motor (30, 31) based on the rotation position of the rotor of each motor (30, 31) measured by each encoder. This allows the control unit 32 to control the operation of each motor (30, 31) while monitoring the speed of each motor (30, 31) as a control quantity.

### Around the battery

The type of battery 40 is not particularly limited, and may be selected appropriately depending on the embodiment. In one example, the battery 40 may be configured by a secondary battery such as a lithium-ion rechargeable battery, nickel-metal hydride rechargeable battery, etc. The battery 40 may be connected to the electric power line 49 along with each inverter (33, 34). This allows the battery 40 to be connected to the motor 30 (generator) through the electric power line 49. By connecting the battery 40 to the motor 30, the hybrid vehicle V1 may be configured to be able to charge the battery 40 with power generated by the motor 30 driven by the engine 10. The battery 40 may also be connected to the motor 31 via a electric power line 49. By connecting the battery 40 to the motor 31, the hybrid vehicle V1 may be configured to obtain driving force by driving the motor 31 with the power of the battery 40. In one example, the hybrid vehicle V1 may further comprise a control unit 45 for the battery 40, and the state of the battery 40 may be managed by the control unit 45.

The configuration of the control unit 45 may be determined arbitrarily. In one example, similar to the control unit 11, the control unit 45 may be configured by an ECU including a processor, a memory, an input/output port, a communication port, and the like. The control unit 45 may accept inputs of various information (such as sensor signal) used for the management of the battery 40 by means of an input port. The various information may include, for example, the voltage of the battery 40, the current at the output terminal of the battery 40, the temperature of the battery 40, and the like. The voltage of the battery 40 may be measured by a voltage sensor 41 installed across the terminals of the battery 40 . The current at the output terminal may be measured by means of a current sensor 43 installed at the output terminal of the battery 40. The temperature of the battery 40 may be measured by a temperature sensor attached to the battery 40. Similarly to the control unit 11, the control unit 45 may be connected to the control device 60 via a communication port and a network. The control unit 45 may be configured to output data on the status of the battery 40 to the control device 60. In one example, the control unit 45 may calculate the remaining energy based on the accumulated value of the current measured by the current sensor 43. The remaining energy may be the amount of electric power that can be discharged from the battery 40 relative to the total capacity of the battery 40. The remaining energy may be calculated as a state of charge (SOC). The calculation method of remaining energy is not limited to such examples, and may be changed according to the form of implementation. The control unit 45 may also calculate the input/output limit based on the calculated remaining energy and the temperature measured by the temperature sensor. The input limit is the maximum allowable electric power when charging battery 40, and the output limit is the maximum allowable electric power when discharging from battery 40. The value of the input/output limit may be determined by any means. For example, the input/output limits of the battery 40 may be calculated by (1) setting a basic value for the input/output limits based on the temperature of the battery 40, (2) setting a correction coefficient based on the remaining energy of the battery 40, and (3) multiplying the correction coefficient by the basic value. In one example, the output limit of the battery 40 may be set to be smaller as the temperature of the battery 40 moves further away from the allowable temperature range on the higher or lower side, and to be smaller as the remaining energy of the battery 40 decreases. The input limit of the battery 40 may be set to be larger (smaller in absolute value) the further the temperature of the battery 40 is from the higher or lower side of the allowable temperature range, and to be larger (smaller in absolute value) the higher the remaining energy level of the battery 40.

### External power supply connector

The external power supply connector 55 may be connected to the electric power line 49 via the charger/discharger 50 . The external power supply connector 55 may be connected to an external device E1. As a result, the external power supply connector 55 in this embodiment is configured to supply electric power from the power line 49 (at least one of the electric power from the battery 40 and the electric power generated by the motor 30 when the engine 10 is driven) to the connected external device E1. The type of the external power supply connector 55 and the method of connecting to the external device E1 are not particularly limited, and may be selected appropriately depending on the embodiment. In one example, the external power supply connector 55 may be configured as a socket that directly accepts connection of the attachment plug of the external device E1. In another example, the external power supply connector 55 may be configured to receive a connection of a dedicated attachment such as a vehicle power connector, and to be indirectly connected to the external device E1 via the attachment. The electric power output from the external power supply connector 55 may be either DC or AC. In one example, the charger/discharger 50 may be configured to convert the DC power of the electric power line 49 to AC power and supply the resulting AC power to external equipment E1 connected to the external power supply connector 55 by comprising an inverter. The charger/discharger 50 may be configured to supply DC electric power from electric power line 49 to the external device E1. The operation of the charger/discharger 50 may be controlled by a control device 60 . Supplying the electric power of the electric power line 49 to the external device E1 may be referred to as "external power supply."

Furthermore, the number of external power supply connector 55 may be determined arbitrarily. In one example, the hybrid vehicle V1 may be provided with a plurality of external power supply connectors 55. Each external power supply connector 55 may be connected to the electric power line 49 via a charger/discharger 50 . When the hybrid vehicle V1 includes a plurality of external power supply connectors 55, the types of the external power supply connectors 55 and the methods of connection with the external device E1 may be the same or may be at least partially different.

The type of the external device E1 is not particularly limited, and may be selected appropriately depending on the embodiment. The external device E1 may include, for example, an electrical appliance such as a mobile terminal or a notebook PC (Personal Computer). The mobile device may include a smartphone, a tablet device, etc. The external device E1 may include facilities such as a home. The external power supply connector 55 may be configured to be connectable to a charging facility. Alternatively, the hybrid vehicle V1 may be further equipped with other connectors that are connected to the electric power line through the charger and discharger, and the other connectors may be configured to connect to the charging facility. This allows the hybrid vehicle V1 to be configured to charge the battery 40 by electric power from the connected charging facility.

### Around the antenna

The antenna 80 is configured to receive signal emitted from the electronic key U1. The types and communication standards of the Antenna 80 do not need to be particularly limited and may be selected according to the form of implementation. The electronic key U1 may be called a smart key. The type of the electronic key U1 is not particularly limited and may be selected appropriately depending on the embodiment. In one example, the electronic key U1 may be configured as a dedicated device or may be configured as a general-purpose device such as a mobile terminal (smartphone, tablet terminal, etc.). For electronic key U1, a publicly known electronic key may be used. The electronic key U1 may be configured to automatically transmit a signal for authentication, or may be configured to manually transmit at least a portion of the signal for authentication in response to an operation by the user Z1. The signal received by the antenna 80 may be processed in any way. The configuration for processing the signal may be determined according to the form of implementation. In one example, the hybrid vehicle V1 may further comprise a control unit 81 for the antenna 80, and the state of the antenna 80 may be managed by the control unit 81.

The configuration of the control unit 81 may be determined arbitrarily. In one example, similar to the control unit 11, the control unit 81 may be configured by an ECU including a processor, a memory, an input/output port, a communication port, and the like. The control unit 81 may receive, via an input port, an input of a signal received by the antenna 80. The control unit 81 may also be connected to the control device 60 via a network via a communication port. The control unit 81 may be configured to output data relating to the received signal of the antenna 80 to the control device 60 .

The attributes (dimensions, shape, material, etc.) of the antenna 80 are not particularly limited and may be determined appropriately depending on the embodiment. The area (communication range) in which communication with the electronic key U1 is possible may depend on the number and arrangement of the antennas 80 as well as the attributes of the antennas 80. The number and arrangement of the antennas 80 are not particularly limited and may be selected appropriately depending on the embodiment. The hybrid vehicle V1 may be equipped with one or more antennas 80. Each of the one or more antennas 80 may be disposed anywhere on the hybrid vehicle V1.

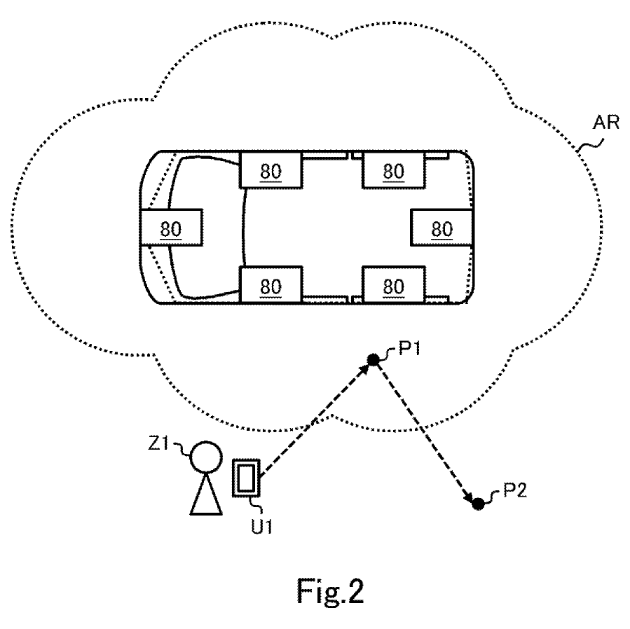

FIG. 2 shows a schematic diagram of an example of a communication range AR of a hybrid vehicle V1. In one example in FIG. 2, the hybrid vehicle V1 is envisioned in a situation where it has six antennas 80. In addition, there are four door sections on the sides of the hybrid vehicle V1, and each of the 80 antennas is envisioned to be located around the front, each of the side door sections, and the rear of the hybrid vehicle V1. In this situation, the communication range of each antenna 80 is formed around each antenna 80, thereby forming a communication range AR that covers the periphery of the hybrid vehicle V1. For example, user Z1 can move the electronic key U1 to a position (e.g., position P1) within the communication range AR, such as moving to position P1 while holding the electronic key U1, thereby causing the antenna 80 to receive the signal emitted from the electronic key U1. On the other hand, at positions outside the communication range AR (e.g., position P2), signals from the electronic key U1 are not received by any of the 80 antennas. Therefore, the signal from the electronic key U1 is disrupted when the electronic key U1 is released from the communication range AR to a position outside the communication range AR, for example, when the user Z1 moves to position P2 with the electronic key U1 in his/her possession. Thereafter, by moving the electronic key U1 again to a position within the communication range AR, the antenna 80 can again receive the signal transmitted from the electronic key U1.

### Control device

Returning to FIG. 1, the control device 60 is installed in the hybrid vehicle V1. The configuration of the control device 60 may be determined arbitrarily. In one example, similar to the control unit 11, the control device 60 may be configured by an ECU including a processor 601, a memory 602, an input/output port, a communication port, etc. The type of the processor 601 may be selected arbitrarily. For example, the processor 601 may be configured by a CPU (Central Processing Unit), a microprocessor, an FPGA (Field-Programmable Gate Array), an ASIC (Application Specific Integrated Circuit), or the like. The type of memory 602 may be selected arbitrarily. For example, the memory 602 may be configured with RAM, ROM, semiconductor memory, etc. The memory 602 may store various types of information such as control programs. The control program may include various instructions for controlling the operation of the hybrid vehicle V1.

The control device 60 may accept inputs of various information (sensor signal, data from other control units, etc.) used to control the hybrid vehicle V1 through the input port. The various information may include signals from the operation device 70, operation information from the operation device 70, and the like. Operation information of the operation device 70 may be obtained by a sensor. For example, the operating device 70 may include an ignition switch, and the various information may include an ignition signal. The operating device 70 may include a shift lever, and the various information may include the operating position (shift position) of the shift lever. The operating position of the shift lever may be measured by a shift position sensor. The operation device 70 may include an accelerator pedal, and the various information may include the amount of depression of the accelerator pedal (accelerator opening). The accelerator opening may be measured by an accelerator pedal position sensor. The operation device 70 may include a brake pedal, and the various information may include the amount of depression of the brake pedal (brake pedal position). The brake pedal position may be measured by a brake pedal position sensor. The various information may also include the electric power supplied from the external power supply connector 55 in the external power supply, the vehicle speed of the hybrid vehicle V1, and the like. The electric power may be measured by a electric power sensor. The vehicle speed of the hybrid vehicle V1 may be measured by the vehicle speed sensor. The control device 60 may output a control signal to the charger/discharger 50 via the output port. The control device 60 may be connected to each control unit (11, 32, 45, 81) via a communication port. As a result, the control device 60 may receive various data from each control unit (11, 32, 45, 81). The control device 60 may output a control signal to each control unit (11, 32, 45, 81).

The operation device 70 may also include an input device. The control device 60 may be connected to an input device. The various information may include operations (inputs) of the input device. The type of input device may be selected arbitrarily. Input devices may include, for example, a touch panel, an operation element, a microphone, and the like. Additionally, the control device 60 may be connected to an output device. The type of output device may be selected arbitrarily. The output device may include, for example, a display, a speaker, and the like. The control device 60 may output any information to an output device. The control device 60 may be connected to input and output devices in any manner. In one example, the control device 60 may be directly connected to input and output devices by input/output ports. In another example, the control device 60 may be indirectly connected to input and output devices via a device such as a control unit (ECU, etc.) through a communication port.

The control device 60 may appropriately control the operation of the hybrid vehicle V1. In one example, when the hybrid vehicle V1 is being driven and the operating position of the shift lever is the drive position (D position) or the reverse position (R position), the control device 60 may set the driving force required of the drive shaft 26 based on the accelerator opening and the vehicle speed. The control device 60 may control the operation of the engine 10 and each motor (30, 31) so that the mechanical power corresponding to the set driving force is output to the drive shaft 26. The mechanical power output to the drive shaft 26 may be obtained from at least one of the engine 10 and the battery 40. For operation control during operation, the method of public knowledge such as Patent Literature 1 may be adopted.

### Control device/execution of external power supply

The control device 60 may be configured to perform external power supply by battery 40 to external equipment E1 according to the establishment of predetermined operating conditions. External power supply by battery 40 is to supply electric power from battery 40 to external device E1 through an external power supply connector 55. The operating conditions may be set arbitrarily. In one example, the operating conditions may be that an external device E1 is connected to the external power supply connector 55, the operating position of the shift lever is the parking position (P position), and an instruction to execute external power supply is given. An instruction to execute external power feeding may be given arbitrarily. For example, the execution instruction of the external power supply may be given in response to the user turning on a switch for external power supply in an input device. The switch for external power supply may be either a software switch (touch panel, etc.) or a physical switch (operation element, etc.).

### Control device/battery charging start

In the present embodiment, the control device 60 allows the charging of the battery 10 by driving the engine 10 with the authentication of the electronic key U1 as a trigger after initiating the external power supply. Specifically, the control device 60 is configured to perform waiting for the antenna 80 to receive the signal from the electronic key U1 while continuing to supply electric power from the battery 40 to the external device E1 through the external power supply connector 55, determining whether or not an authentication of the electronic key U1 is established based on the signal received by the antenna 80, and in response to the authentication of the electronic key U1 being established, starting charging the battery 40 by driving the engine 10 to cause the motor 30 to generate electric power.

Waiting for the signal to be received may be monitoring the signal reception status. In one example, when the control unit 81 receives a signal via the antenna 80 , it may output data relating to the received signal to the control device 60 . The control device 60 may wait (monitor) for the antenna 80 to receive a signal from the electronic key U1 by receiving signal from the control unit 81. As a result of the standby state, a signal from the electronic key U1 may be received in response to transmission within the communication range of the antenna 80. Authentication of the electronic key U1 may be performed as appropriate for the received signal. Authentication of the electronic key U1 may be performed by a known method, such as comparing authentication information indicated by a received signal with information stored in a memory. The authentication process of the electronic key U1 may be performed on the control device 60, or on a computer other than the control device 60 (such as the control unit 81). When the authentication process is performed on the control unit 81, waiting for reception of a signal and determining whether authentication of the electronic key U1 is successful may be performed by having the control unit 81 monitoring the signal reception status and receiving data indicating the authentication result from the control unit 81.

In this embodiment, charging the battery 10 by driving engine 40 is prohibited until the authentication of the electronic key U1 is established. Allowing or prohibiting the charging of the battery 10 by driving the engine 40 can be controlled by arbitrary information such as flags. Upon successful authentication of the electronic key U1, the controller 60 may permit charging of the battery 40 by driving the engine 10. In the present embodiment, the control device 60 starts charging the battery 40 by driving the engine 10 by giving control signals to each control unit (11, 32). On the other hand, when the authentication of the electronic key U1 fails, the control device 60 does not start charging the battery 10 by driving the engine 40. The control device 60 may maintain a state in which the charging of the battery 40 is prohibited by driving the engine 10.

The driving conditions (drive amount, torque, rotation speed, etc.) of the engine 10 when charging the battery 40 are not particularly limited, and may be determined appropriately depending on the embodiment. In one example, a plurality of modes may be prepared, each of which defines a driving condition. In this case, the control device 60 may determine the control command to be given to each control unit (11, 32) in accordance with the driving conditions defined in one mode selected from a plurality of prepared modes. In addition, a part of the electric power generated by the motor 30 driven by the engine 10 may or may not be supplied to the external device E1. This external power supply mode in which the electric power of the battery 40 is automatically supplemented by driving the engine 10 may be referred to as an HV power supply mode. Additionally, the hybrid vehicle V1 may be configured to be able to operate in an EV power supply mode in which the engine 10 is not driven and only the electric power of the battery 40 is used for external power supply.

### Control device/battery charging after authentication is successful

After being started in response to successful authentication of the electronic key U1, the charging of battery 40 by the engine 10 may be operated accordingly. As an example, the control device 60 may operate the charging of the battery 40 by driving the engine 10 in at least one of the following two modes.

### 1 First mode

In the first mode, after the authentication of the electronic key U1 is established, the control device 60 may permit the engine 10 to be driven to charge the battery 40 according to the remaining energy. In one example, charging the battery 40 by driving the engine 10 in response to the lower limit of energy remaining in the battery 40 may be prohibited until the authentication of the electronic key U1 is established. The control device 60 configured to further perform terminating the charging of the battery 40 according to the authentication of the electronic key U1 being established by stopping driving the engine 10 when a predetermined condition is satisfied, and after terminating the charging of the battery 40 according to the authentication of the electronic key U1 being established, permitting the charging of the battery 40 by driving the engine 10 according to the remaining energy of the battery 40 reaching the lower limit (the first lower limit).

The predetermined condition is not particularly limited and may be determined appropriately depending on the embodiment. The predetermined condition may be, for example, that a certain amount of time has elapsed, that charging has been completed up to a predetermined amount, or the like. In one example, if the predetermined condition is that a certain amount of time has elapsed, the control device 60 may further comprise a timer. The control device 60 may monitor by a timer whether a certain amount of time has elapsed after starting to charge the battery 40 driven by engine 10. The control device 60 may terminate charging of the battery 40 according to authentication of the electronic key U1 by sending a control signal to each control unit (11, 32) in response to the passage of a certain period of time. In one example, when the predetermined condition is that a predetermined amount of charging has been completed, the control device 60 may monitor the remaining energy of the battery 40 . The remaining energy of the battery 40 may be monitored in any manner. In one example, the control unit 45 may calculate the remaining energy amount of the battery 40 and transmit data indicating the calculated remaining energy amount (calculation result) to the control device 60. The control device 60 may monitor the remaining energy of the battery 40 by receiving this data. The timing for monitoring the remaining energy may be determined arbitrarily. The control unit 45 may repeatedly perform the calculation of the remaining energy of the battery 40 and the transmission of the calculation results to the control device 60. This allows the control device 60 to continuously monitor the remaining energy of the battery 40 through the control unit 45. The control device 60 may determine whether the remaining energy of battery 40 has reached a predetermined amount based on the monitoring results. The predetermined amount is the threshold that serves as a basis for terminating the charging of battery 40 according to the authentication of the electronic key U1 being established. The predetermined amount may be arbitrarily defined. The predetermined amount may be, for example, a full charge or any other arbitrary value. When the remaining energy acquired as a result of monitoring is less than the predetermined amount, the control device 60 may determine that the remaining energy has not reached the predetermined amount. On the other hand, when the acquired remaining energy exceeds the predetermined amount, the control device 60 may determine that the remaining energy has reached the predetermined amount. When the remaining energy obtained is equal to the predetermined amount, the control device 60 may determine that the remaining energy has reached the predetermined amount, or determine that the remaining energy has not reached the predetermined amount. When it is determined that the remaining energy has not reached the predetermined amount, the control device 60 may continue to charge the battery 40 according to the authentication of the electronic key U1 being established. On the other hand, when it is determined that the remaining energy amount has reached the predetermined amount, the control device 60 may terminate charging of the battery 40 according to the authentication of the electronic key U1 being established.

Furthermore, permitting charging of the battery 40 may be implemented by any information processing that allows charging of the battery 40 to be performed, such as updating a flag to a value indicating permission. This information processing regarding permission may be executed at any timing after the authentication of the electronic key U1 is established and before the remaining energy of the battery 40 reaches the lower limit (first lower limit).

In response to permitting the battery 40 to be charged according to the remaining energy, the control device 60 may continuously monitor the remaining energy of the battery 40. The control device 60 may determine whether the remaining energy of battery 40 has reached the lower limit (the first lower limit) based on the monitoring results. The lower limit (the first lower limit) is the threshold that serves as a basis for starting charging the battery 10 by driving the engine 40. The lower limit (first lower limit) may be defined arbitrarily. When the remaining energy obtained as a result of monitoring exceeds the lower limit, the control device 60 may determine that the remaining energy has not reached the lower limit. On the other hand, when the acquired remaining energy is less than the lower limit, the control device 60 may determine that the remaining energy has reached the lower limit. When the remaining energy obtained is equal to the lower limit, the control device 60 may determine that the remaining energy has reached the lower limit, or that the remaining energy has not reached the lower limit. The control device 60 may start charging the battery 40 by driving the engine 10 by giving a control signal to each control unit (11, 32) in response to determine that the remaining energy of the battery 40 has reached the lower limit.

After starting to charge the battery 40, the control device 60 may continuously monitor the remaining energy of the battery 40 while continuing to charge. The control device 60 may determine whether the remaining energy of battery 40 has reached the upper limit based on the monitoring results. The upper limit is the threshold that is a criterion for terminating charging of the battery 40 by driving the engine 10. The upper limit may be defined arbitrarily. When the remaining energy obtained as a result of monitoring is less than the upper limit, the control device 60 may determine that the remaining energy has not reached the upper limit. On the other hand, when the acquired remaining energy exceeds the upper limit, the control device 60 may determine that the remaining energy has reached the upper limit. When the remaining energy obtained is equal to the upper limit, the control device 60 may determine that the remaining energy has reached the upper limit, or that the remaining energy has not reached the upper limit. When it is determined that the remaining energy has not reached the upper limit, the control device 60 may continue to charge the battery 40 by driving the engine 10. On the other hand, in response to determine that the remaining energy has reached the upper limit, the control device 60 may terminate charging of the battery 40 by driving the engine 10 by sending a control signal to each control unit (11, 32).

According to this first mode, the timing at which the engine 10 starts to be driven for the first time in the HV power supply can be controlled through authentication of the electronic key U1. After the initial drive of the engine 10 is controlled, the battery 40 can be charged in accordance with the remaining energy amount. When charging of the battery 40 in response to the authentication of the electronic key U1 being established at a stage when the remaining amount of energy in the battery 40 is less than the upper limit, the upper limit may be adopted for the above predetermined amount. When terminating the external power supply, the controller 60 may again prohibit charging of the battery 40 by driving the engine 10 in response to the remaining amount of energy in the battery 40 reaching the lower limit amount.

### 2 Second mode

In the second mode, the control device 60 may permit charging of the battery 40 by driving the engine 10 only while authentication of the electronic key U1 is established. In one example, the control device 60 configured to continuously perform the waiting to receive the signal from the electronic key U1 and determining whether or not the authentication of the electronic key U1 is established even after the battery 40 is started charging, continue charging the battery 40 while the authentication of the electronic key U1 is established, and terminate charging of the battery 40 by stopping driving the engine 10 in response to a loss of the signal from the electronic key U1 or the authentication of the electronic key U1 not being established.

The loss of the signal from the electronic key U1 may be that the signal from the electronic key U1 no longer reaches the antenna 80 due to, for example, moving from the communication range of the antenna 80 out of the communication range (moving from position P1 in FIG. 2 to position P2, etc.) or shielding of the signal from the electronic key U1. The failure of electronic keyU1 authentication may be, for example, that electronic keyU1 is not legitimate (replaced by a non-legitimate key).

In this second mode, by maintaining authentication of the electronic key U1, it is possible to continue charging the battery 40 by driving the engine 10, which began in response to authentication of the electronic key U1. By stopping the authentication of the electronic key U1, you can stop charging the battery 10 driven by engine 40. Thus, according to the second form, the driving period of the engine can be controlled through the authentication of the electronic key U10.

Note that, for example, there may be situations where it is not necessary to continue charging the battery 40 even if the authentication of the electronic key U1 has been established, such as when the remaining energy of the battery 40 reaches a full charge. So, in one example, when adopting the second mode, the control device 60 may continuously monitor the remaining energy of the battery 40 while continuing to charge the battery 40 by driving the engine 10. And even while the authentication of the electronic key U1 is established, the control device 60 may terminate the charging of the battery 40 by stopping the engine 10 as the remeining energy of the battery 40 reaches a predetermined amount as a result of monitoring. The determination of whether or not the remaining energy has reached the predetermined amount may be the same as the determination of the predetermined condition (predetermined amount) in the first mode above. The predetermined amount may be arbitrarily defined. The predetermined amount may be, for example, a full charge, or other arbitrary values. In addition, immediately after the battery 40 is finished charging with this condition met, the battery 40 has accumulated sufficient remaining energy. Therefore, in one example, after charging the battery 40 is terminated in response to the remaining energy reaching the predetermined amount, the control device 60 may not accept charging of the battery 40 by driving the engine 10 according to successful authentication of the electronic key U1 for a certain period of time. For example, the control device 60 may not receive a signal from the electronic key U1 for a certain period of time. Also, for example, the control device 60 may not start charging the battery 40 by driving the engine 10 for a certain period of time even if the authentication of the electronic key U1 is established.

### Control device/stopping external power supply

The external power supply may be stopped at any time such as user operation. In one example, the control device 60 configured to further perform stopping supplying electric power from the battery 40 to the external device E1 (external power supply) when the remaining energy of the battery 40 reaches the lower limit (the second lower limit) before the authentication of the electronic key U1 is established. For example, the control device 60 may continuously monitor the remaining energy of the battery 40 before authenticating the electronic key U1. The controller 60 may stop the external power supply by controlling the charging/discharging unit 50 in response to the fact that the remaining energy in the battery 40 has reached the lower limit (second lower limit) as a result of monitoring. The determination of whether or not the remaining energy has reached the lower limit (the second lower limit) may be the same as whether or not the remaining energy has reached the lower limit (the first lower limit) when charging a battery 40 according to the remaining energy described above. In the case of adopting the first mode above, the control device 60 may stop the external power supply as the remaining energy of the battery 40 reaches the lower limit before permitting the battery 40 to be charged according to the remaining energy of the battery 40 due to successful authentication of the electronic key U1. The lower limit (second lower limit) is the threshold that serves as a reference for stopping external power supply. This lower limit (second lower limit) may be the same as or different from the lower limit (first lower limit) that is the reference for starting charging of the battery 40 by driving the engine 10. On the other hand, in the case of adopting the second mode above, the period during which the authentication of the electronic key U1 has not been established corresponds to the period before the authentication of the electronic key U1 is established. The control device 60 may stop the external power supply when the remaining energy of the battery 40 reaches the lower limit during the period when the authentication of the electronic key U1 has not been established. According to one example of the present embodiment, by stopping the external power supply before the remaining energy of the battery 40 is exhausted, the remaining energy for use other than external power supply such as driving can be secured. In addition, after the external power supply is terminated, the battery 40 may be charged accordingly. After the battery 40 is charged, external power supply may be carried out again.

### Types of Hybrid vehicle

As long as the hybrid vehicle V1 is equipped with an internal combustion engine and a battery 40, the type of the hybrid vehicle V1 is not particularly limited, and may be selected appropriately depending on the embodiment. In one example, the hybrid vehicle V1 may include a hybrid electric vehicle (HEV), a plug-in hybrid electric vehicle (PHEV), or the like. The attributes of the hybrid vehicle V1 (size, number of wheels, etc.) are not particularly limited, and may be selected appropriately depending on the embodiment. The hybrid vehicle V1 may include a manually driven vehicle and an autonomous vehicle.

### Example of operation

### First mode

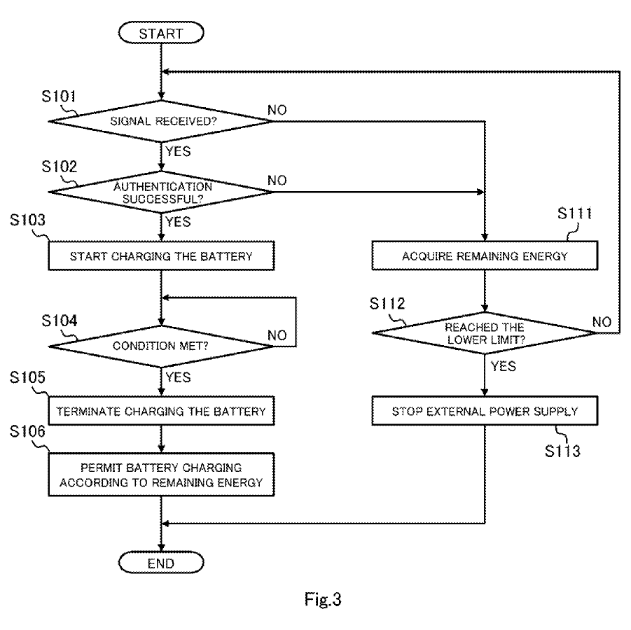

FIG. 3 is a flowchart indicating an example of a processing procedure related to HV power supply by the control device 60 when the first mode is adopted. The processor 601 of the control device 60 executes instructions contained in a program stored in the memory 602 . This allows control device 60 to operate as a computer capable of executing information processing of FIG. 3. The following processing procedure in FIG. 3 is an example of an information processing method executed by a computer (control device 60). However, the following processing procedure is merely an example, and each step may be modified as much as possible. Steps in the following processing procedure may be omitted, replaced, or added as appropriate depending on the embodiment. Furthermore, the following operation of the control device 60 may be interpreted as the operation of the processor 601. The control device 60 may start executing the processing procedure in FIG. 3 at any timing when external power feeding is being performed in the HV power supply feeding mode. In one example, control device 60 may start executing the processing procedure of FIG. 3 when the execution of external power supply in HV power supply mode starts. External power supply may be performed at any timing. In one example, the control device 60 may start external power supply from the battery 40 to the external device E1 in response to the establishment of a predetermined operating condition. Furthermore, when a plurality of power supply modes are prepared, the power supply mode to be used may be appropriately selected from the plurality of power supply modes. When the HV power supply mode is selected, the control device 60 may start executing the processing procedure of FIG. 3. When the processing procedure of FIG. 3 is started, charging of the battery 40 by driving the engine 10 may be prohibited.

In step S101, the control device 60 waits for the antenna 80 to receive a signal from the electronic key U1 while continuing the external power supply. When a signal has been received from the electronic key U1, the control device 60 proceeds to the next step S102. On the other hand, when a signal from the electronic key U1 has not been received, the control device 60 proceeds to step S111. In step S102, the control device 60 determines whether or not the authentication of the electronic key U1 is established based on the signal received by the antenna 80. When the authentication of the electronic key U1 is established (successful), the control device 60 proceeds to the next step S103. On the other hand, when the authentication of the electronic key U1 is not established, the control device 60 proceeds to step S111. In step S103, in response to the authentication of the electronic key U1 being established, the control device 60 starts charging the battery 40 by driving the engine 10 to cause the motor 30 to generate electric power. After starting charging the battery 40, the control device 60 proceeds to the next step S104. In step S104, the control device 60 determine whether or not the predetermined condition is met. When the predetermined condition is satisfied, the control device 60 proceeds to the next step S105. On the other hand, when the predetermined condition is not satisfied, the control device 60 executes the process of step S104 again. As a result, the control device 60 continues charging the battery 40 according to the authentication of the electronic key U1 being established until the predetermined condition is met. In step S105, the control device 60 stops the operation of the engine 10 in response to the satisfaction of the predetermined condition, thereby terminating the charging of the battery 40 according to the authentication of the electronic key U1 being established. After charging the battery 40 is completed, the control device 60 proceeds to the next step S106.

In step S106, the control device 60 permits the charging of the battery 40 by driving the engine 10 according to the remaining energy of the battery 40 reaching the lower limit amount (first lower limit amount). After permitting charging of the battery 40, the control device 60 ends the processing procedure according to this operation example. Thereafter, the control device 60 may charge the battery 40 in accordance with the remaining energy while the external power supply continues. The timing for executing the process of step S106 is not limited to this example. Step S106 may be executed at any timing after authentication is established in step S102.

In step S111, the control device 60 acquires (monitors) the remaining energy of the battery 40. In step S112, the control device 60 determine whether the acquired remaining energy has reached the lower limit (second lower limit). When the remaining energy has reached the lower limit (second lower limit), the control device 60 proceeds to step S113. On the other hand, when the remaining energy has not reached the lower limit (second lower limit), the control device 60 returns the process to step S101 and executes the process again from step S101. In step S113, the control device 60 stops the external power supply. In response to the stop of the external power supply, the control device 60 ends the processing procedure according to this operation example. It should be noted that the control device 60 may execute a series of processes from step S101 to step S106 and step S111 to step S113 in real time while external power supply is being performed. Furthermore, the control device 60 may end the above processing procedure at any timing in response to the end of external power supply, a user instruction, or the like.

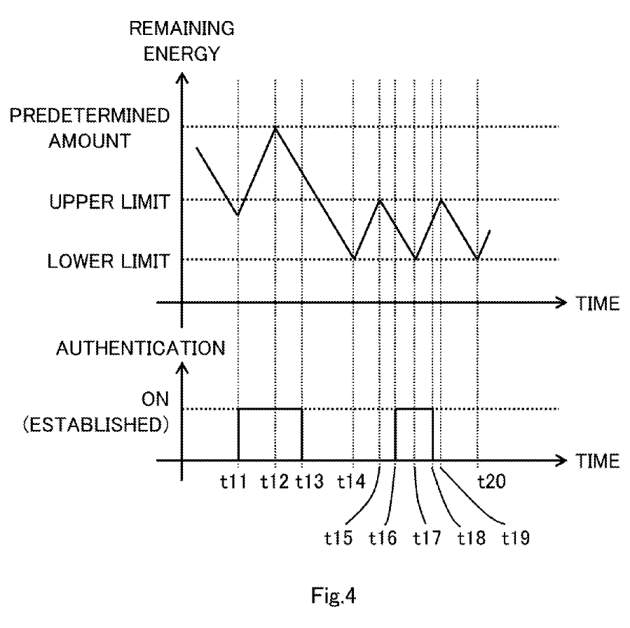

FIG. 4 indicate a schematic example of the relationship between the authentication of electronic key U1 and remaining energy of the battery 40 when HV power supply is performed in the processing procedure of FIG. 3. In FIG. 4, it is assumed that the electric power consumed by the battery 40 due to external power supply is constant, and that authentication of the electronic key U1 is successful between time t11 and time t13 and between time t16 and time t18. When the processing procedure of FIG. 3 is adopted, charging of the battery 40 is started in step S103 in response to successful authentication at time t11. In FIG. 4, a situation is assumed in which the predetermined condition is that charging has been completed up to a predetermined amount. At time t12, the remaining energy of the battery 40 reaches a predetermined amount, and the charging of the battery 40 is completed by the processing in step S105. Then, the processing of step S106 permits charging of the battery 40 according to the remaining energy amount. Accordingly, at times t14, t17, and t20 when the remaining energy amount of the battery 40 reaches the lower limit, charging of the battery 40 by driving the engine 10 is started regardless of whether authentication was successful between times t16 and t18. At times t15 and t19 when the remaining energy of the battery 40 reaches the upper limit, charging of the battery 40 by driving the engine 10 is completed.

As shown in FIG. 4, according to this embodiment, the timing (time t11) at which the engine 10 starts to operate in HV power supply can be controlled through the processing of steps S101 to S103, via authentication of the electronic key U1. Furthermore, according to one example of this embodiment, after controlling the initial drive of the engine 10, the process of step S106 can charge the battery 40 according to the remaining energy. In the example of FIG. 4, if the remaining energy reaches the lower limit amount (second lower limit amount) before time t11, the control device 60 may stop the external power feeding by the process of step S113.

### Second mode

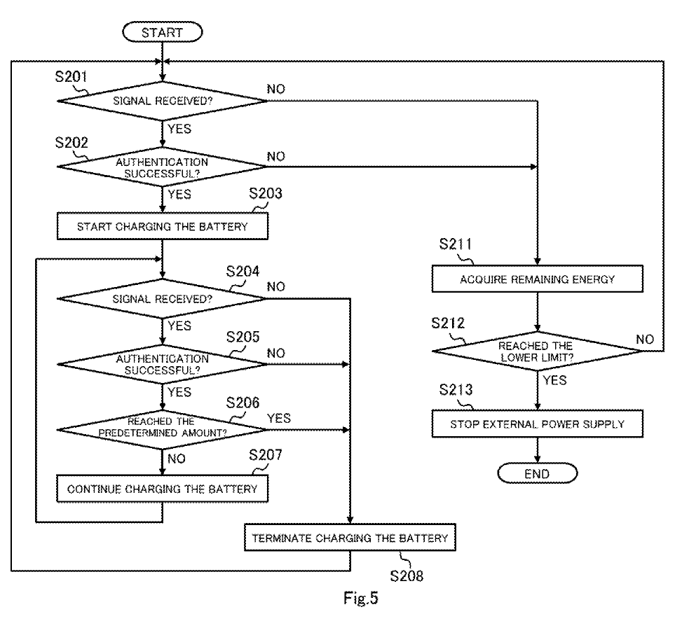

FIG. 5 is a flowchart indicating an example of a processing procedure related to HV power supply by the control device 60 when the second mode is adopted. The processor 601 of the control device 60 executes instructions contained in a program stored in the memory 602 . This allows control device 60 to operate as a computer capable of executing information processing of FIG. 5 . The following processing procedure in FIG. 5 is an example of an information processing method executed by a computer (control device 60). However, the following processing procedure is merely an example, and each step may be changed as much as possible. Steps in the following processing procedure may be omitted, replaced, or added as appropriate depending on the embodiment. The following operations of the control device 60 may be interpreted as operations of the processor 601. As with the processing procedure in FIG. 3, the control device 60 may start executing the processing procedure in FIG. 5 at any timing when external power feeding in the HV power supply feeding mode is being performed. When the processing procedure of FIG. 5 is started, charging of the battery 40 by driving the engine 10 may be prohibited.

In step S201, the control device 60 waits for the antenna 80 to receive a signal from the electronic key U1 while continuing the external power supply. When the signal has been received from the electronic key U1, the control device 60 proceeds to the next step S202. On the other hand, When the signal from the electronic key U1 has not been received, the control device 60 proceeds to step S211. In step S202, the control device 60 determines whether or not the authentication of the electronic key U1 is established based on the signal received by the antenna 80. When the authentication of the electronic key U1 is established (successful), the control device 60 proceeds to the next step S203. On the other hand, When the authentication of the electronic key U1 is not established, the control device 60 proceeds to step S211. In step S203, in response to the authentication of the electronic key U1 being established, the control device 60 starts charging the battery 40 by driving the engine 10 to cause the motor 30 to generate electric power. After starting charging the battery 40, the control device 60 proceeds to the next step S204. Steps S201 to S203 may be processed in the same manner as steps S101 to S103 in FIG. 3.

In step S204, similar to step S201, the control device 60 waits for the antenna 80 to receive a signal from the electronic key U1. When the signal has been received from the electronic key U1, the control device 60 proceeds to the next step S205. On the other hand, when the signal from the electronic key U1 has not been received, the control device 60 proceeds to step S208. In step S205, similar to step S202, the control device 60 determines whether or not the authentication of the electronic key U1 is established based on the signal received by the antenna 80. When the authentication of the electronic key U1 is established (successful), the control device 60 proceeds to the next step S206. On the other hand, when the authentication of the electronic key U1 is not established, the control device 60 proceeds to step S208. When the signal from the electronic key U1 is lost or the authentication of the electronic key U1 is not established, the control device 60 proceeds to step S208 by processing step S204 or step S205. When the authentication of the electronic key U1 remains established, the control device 60 proceeds to step S206. In step S206, the control device 60 acquires (monitors) the remaining energy of the battery 40. The control device 60 determine whether the acquired remaining energy has reached the predetermined amount. When the remaining energy has reached the predetermined amount, the control device 60 proceeds to step S208. On the other hand, when the remaining energy has not reached the predetermined amount, the control device 60 proceeds to the next step S207. In step S207, the control device 60 continues charging the battery 40. The control device 60 returns the process to step S204 and executes the process again from step S204. As a result, the processes of steps S204 and S205 are continuously executed. While the authentication of the electronic key U1 remains established, the battery 40 continues to be charged. In step S208, the control device 60 stops the driving of the engine 10, thereby terminating the charging of the battery 40. After charging the battery 40 is completed, the control device 60 returns the process to step S201 and executes the process again from step S201. When the process of step S208 is executed as a result of the determination in step S206, the control device 60 may not accept charging of the battery 40 by driving the engine 10 in response to successful authentication of the electronic key U1 for a certain period of time.

In step S211, the control device 60 acquires (monitors) the remaining energy of the battery 40. In step S212, the control device 60 determine whether the acquired remaining energy has reached the lower limit amount. When the remaining energy has reached the lower limit amount, the control device 60 proceeds to step S213. On the other hand, when the remaining energy has not reached the lower limit, the control device 60 returns the process to step S201 and executes the process again from step S201. In step S213, the control device 60 stops the external power supply. Steps S211 to S213 may be processed in the same manner as steps S111 to S113 in FIG. 3 . In response to the stop of the external power supply, the control device 60 ends the processing procedure according to this operation example. It should be noted that the control device 60 may execute a series of processes from step S201 to step S208 and step S211 to step S213 in real time while external power feeding is being performed. The control device 60 may also terminate the above processing procedure at any timing.

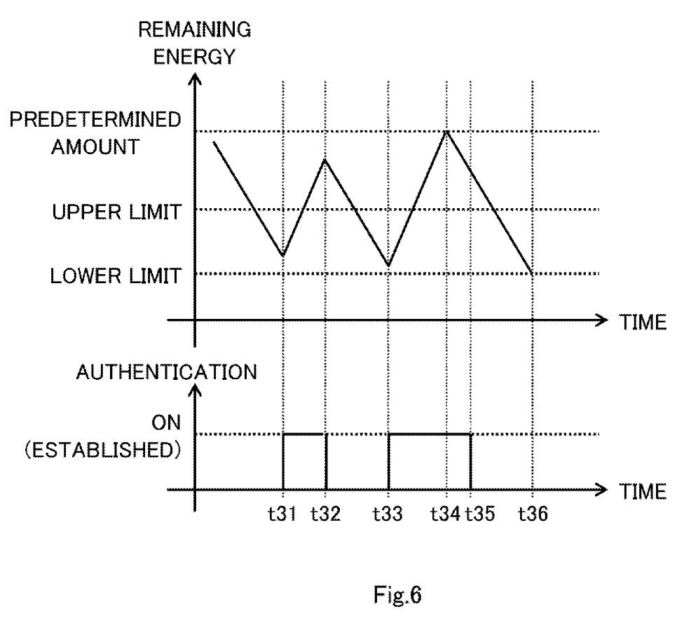

FIG. 6 indicate a schematic example of the relationship between the authentication of electronic key U1 and remaining energy of the battery 40 when HV power supply is performed in the processing procedure of FIG. 5 . In FIG. 5, the electric power consumed by the battery 40 due to external power supply is constant, and it is assumed that authentication of the electronic key U1 is established during the first period from time t31 to time t32 and the second period from time t33 to time t35. When the processing procedure of FIG. 5 is adopted, the processing of steps S201 to S207 allows the engine 10 to continue to drive and charge the battery 40 while the electronic key U1 is authenticated. At time t32, the process proceeds to step S208 from the process of step S204 or step S205, and charging of the battery 40 is completed. In FIG. 6, a situation is assumed in which the remaining energy of the battery 40 reaches a predetermined amount at time t34 during the second period. At this time t34, the process of step S206 proceeds to step S208, and charging of the battery 40 is completed. At time t36, the remaining energy of the battery 40 reaches the lower limit amount. In response to this, the control device 60 may stop the external power feeding by the process of step S213.

As shown in FIG. 6, according to this embodiment, the timing (time t31, time t33) at which the engine 10 starts to operate in HV power supply can be controlled through the processing of steps S201 to S203, via authentication of the electronic key U1. Furthermore, according to one example of this embodiment, the processing of steps S204 to S208 enables the driving period of the engine 10 in HV power supply (time t31-time t32, time t33-time t34/time t35) to be controlled through authentication of the electronic key U1. In the example of FIG. 6, if the remaining energy reaches the lower limit amount before time t31, the control device 60 may stop the external power feeding by the process of step S213.

### Modification

Although the embodiments of the present disclosure have been described above in detail, the above description is merely an example of the present disclosure in every respect. The processes and means described in present disclosure can be freely combined and implemented as long as no technical contradiction occurs. Various improvements or modifications may be made to the above embodiment as appropriate. The configuration of the hybrid vehicle V1 is not limited to the example shown in FIG. FIG. 1, and may be modified as appropriate depending on the embodiment. Regarding the specific hardware configuration of the hybrid vehicle V1, components can be omitted, replaced, or added as appropriate depending on the embodiment.

What is claimed is:

1. A hybrid vehicle comprising:
an internal combustion engine;
a generator configured to generate electric power by mechanical power from the internal combustion engine;
a battery connected to the generator through an electric power line;
an external power supply connector configured to supply electric power from the battery to a connected external device;
an antenna configured to receive a signal emitted by an electronic key; and
an control device configured to perform:
waiting for the antenna to receive the signal from the electronic key while continuing to supply electric power from the battery to the external device through the external power supply connector,
determining whether or not an authentication of the electronic key is established based on the signal received by the antenna, and
in response to the authentication of the electronic key being established, starting charging the battery by driving the internal combustion engine to cause the generator to generate electric power, and
wherein the charging the battery by driving the internal combustion engine is prohibited until the authentication of the electronic key is established.

2. The hybrid vehicle according to claim 1, wherein
charging the battery by driving the internal combustion engine according to a remaining energy of the battery reaching a lower limit is prohibited until the authentication of the electronic key is established, and
the control device configured to further perform:
terminating the charging of the battery according to the authentication of the electronic key being established by stopping driving the internal combustion engine when a predetermined condition is satisfied, and
after terminating the charging of the battery according to the authentication of the electronic key being established, permitting the charging of the battery by driving the internal combustion engine according to the remaining energy of the battery reaching the lower limit.

3. The hybrid vehicle according to claim 1, wherein
the control device configured to:
continuously perform the waiting to receive the signal from the electronic key and the determining whether or not the authentication of the electronic key is established even after the battery is started charging,
continue charging the battery while the authentication of the electronic key is established, and
terminate charging of the battery by stopping driving the internal combustion engine in response to a loss of the signal from the electronic key or the authentication of the electronic key not being established.

4. The hybrid vehicle according to claim 1, wherein
the control device configured to further perform stopping supplying electric power from the battery to the external device when the remaining energy of the battery reaches a lower limit before the authentication of the electronic key is established.

5. A control device installed in a hybrid vehicle comprising an internal combustion engine, a generator configured to generate electric power by mechanical power from the internal combustion engine, a battery connected to the generator through an electric power line, an external power supply connector configured to supply electric power from the battery to a connected external device and an antenna configured to receive a signal emitted by an electronic key, configured to perform:
waiting for the antenna to receive the signal from the electronic key while continuing to supply electric power from the battery to the external device through the external power supply connector,
determining whether or not an authentication of the electronic key is established based on the signal received by the antenna, and
in response to the authentication of the electronic key being established, starting charging the battery by driving the internal combustion engine to cause the generator to generate electric power, and
wherein the charging the battery by driving the internal combustion engine is prohibited until the authentication of the electronic key is established.
